(19) United States
(12) Patent Application Publication
(10) Pub. No.: US 2005/0258329 A1
(43) Pub. Date: Nov. 24, 2005

(54) Device for marking placement of anchors for wall hangings

(76) Inventor: Diane Patricia Fichter, Coral Springs, FL (US)

Correspondence Address: DIANE P. FICHTER, 2453 NW 98 TER., CORAL SPRINGS, FL, 33065, US

(21) Appl. No.: 10/931,690

(22) Filed: Sep. 1, 2004

Related U.S. Application Data
(60) Provisional application No. 60/572,580, filed on May 19, 2004.

(51) Int. Cl. B60R 1/02

(52) U.S. Cl. 248/466

(57) ABSTRACT

A device for marking placement of anchors for a wall hanging includes a membrane. The membrane attaches to the wall hanging. A marking member extends from the membrane. The marking member has a reservoir therein.

### BACKGROUND OF THE INVENTION

This application claims the benefit of my earlier file date of May 19, 2004, application No. 60/572,580. This invention is directed to a device for aiding location and placement for nails/screws and such other hanging anchors on a wall or other flat surface when hanging picture frames, mirrors or shelves.

### BRIEF SUMMARY OF THE INVENTION

Most items which are hung onto a wall or other flat surface have hanging structure attached to the back thereof. By way of non-limiting example, wall hangings such as a picture, mirror, tapestry, shelving or the like may come with a saw-toothed member or a triangular metal member attached to its back, or even wire fixed across two points of the wall hanging by way of example. These structures are provided to catch onto an anchor such as a picture hook, nail or screw affixed to the wall. In the case of shelving, the shelving support may have structures such as a nail or screw opening formed in a bracket or other support member for receiving the screw.

These devices have been known in the art for many years and have effectively hung wall hangings to walls. However, they suffer from the disadvantage that first, in the case of wire, there is some give to the wire so that where the wire is positioned prior to hanging does not correspond to the position of the wire when it is hanging on the hook or screw. Furthermore, to determine where these saw-toothed or triangular members will be positioned relative to the wall to hang a picture/mirror at the appropriate spot requires many measurements to mark the wall prior to insertion of the anchor. Furthermore, compounding the measurement difficulty, is the fact that when there are multiple mirror/picture supports or multiple mirrors/pictures to be mounted, the supports are not uniformly affixed to the mirror/picture so that measurements cannot be taken from one marked spot to another. Therefore, each item to be hung must be independently measured relative to a floor and a position of the support on the picture/mirror.

Accordingly, device for marking the spot for insertion of the anchor along a wall which automatically compensates for position of the wall hanging, without complex measurement is desired.

### BRIEF DESCRIPTION OF THE DRAWINGS

FIG. 1 is a top plan view of the device for marking placement of anchors in accordance with the invention;

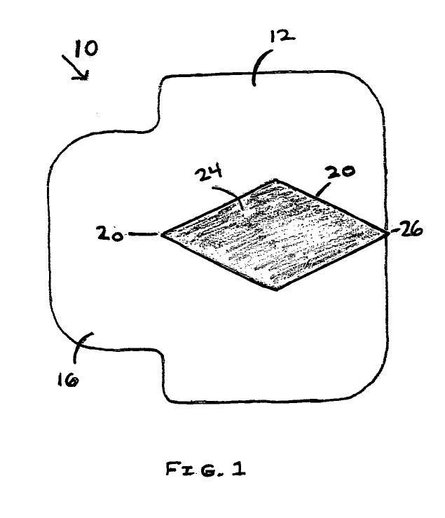

FIG. 2 is a side elevational view thereof, the opposite side being a mirror image thereof; and;

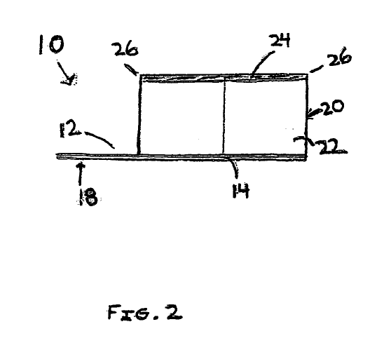

FIG. 3 is a perspective view of the device for marking placement of anchors for wall hangings in accordance with the invention.

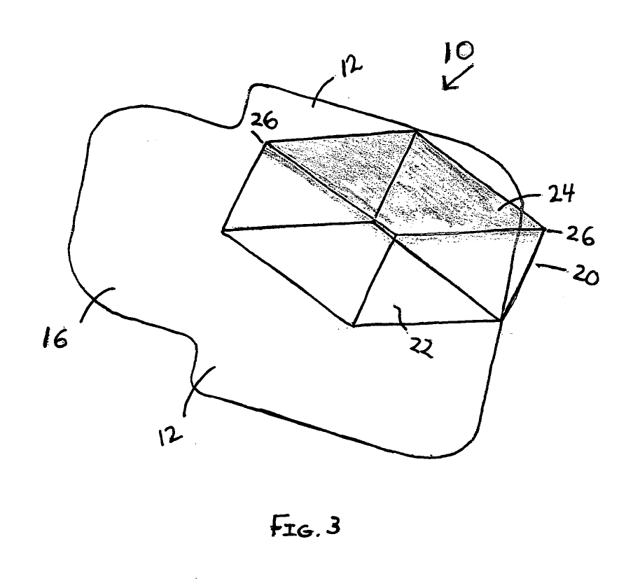

### DETAILED DESCRIPTION OF THE INVENTION

A device for marking placement for wall hangings, generally indicated as 10 includes a membrane 12. One face of membrane 12 is coated with an adhesive 14. As discussed in greater detail below, device 10 is reusable so that adhesive 14 is sufficiently strong to bond and affix device 10 to the back of the wall hanging to be mounted, yet sufficiently weak to allow removal of device 10 while substantially all of adhesive 14 remains with membrane 12 for re-use.

To facilitate removal of membrane 12, membrane 12 is formed with a tab region 16, so that the user may grab membrane 12 and peel membrane 12 away from the wall hanging. As is known in the art, a removable backing 18 may be affixed to membrane 12 by adhesive 14 during transit and prior to use. Tab 16 again aids in separation of membrane 12 and adhesive 14 from backing 18. In a preferred embodiment, membrane 12 is formed of a sheet of plastic or sufficiently rigid paper to support the remaining structure. The adhesive 14, because it substantially remains with membrane 12, is non-marking and will not leave a mark on the wall hanging to which it is attached. In a preferred embodiment membrane 12 is clear to facilitate alignment of the device on the wall hanging.

A marking member, generally indicated as 20 extends from membrane 12 from a second surface of membrane 12 opposed to a surface upon which adhesive 14 is applied. Member 20 includes a base portion 22 and an ink reservoir portion 24 disposed thereon. Marking member 20 is preferably formed at least in part, of a compressible material which is sufficiently absorbent to retain ink in an ink reservoir portion 24. By way of example, member 20 includes a portion formed of a soft rubber, foam or sponge material, or the like, all of which are capable of absorbing and releasing ink and of slight compression. In a preferred embodiment, the ink is washable so that the mark can be erased if necessary.

In a preferred embodiment, the shape of marking member 20 is a diamond to be received by saw-toothed and triangular shaped support members while also replicating, at an end 26 the position of a support screw or nail, when used with wire support members. However, it should be noted that circular or semi-circular shapes may also be used for use with a semi-circular shaped support members. However, the invention is not limited to shape as any shape which can be received, as a nail, screw or picture hook can be received, in a support member, yet provides sufficient surface to provide an ink reservoir for marking a wall is within the scope of the invention.

During use, backing 18 is peeled from adhesive 14. Device 12 is affixed to a wall hanging to be hung so that membrane 12 is affixed to the back of the wall hanging by adhesive 14 such that point 26 is received by the wall hanging support member at the position at which the nail or screw anchor is received by the support member. It should be noted, that the height of member 20 is sufficiently great so that when membrane 12 is affixed to the picture/mirror, reservoir 24 extends beyond the support member.

The wall hanging is then placed against the wall at the position at which it is to be hung. A pressure is applied to the wall hanging so that ink reservoir 24 comes in contact with the wall and leaves a diamond shaped mark. The picture is then removed from the wall and the anchor is placed on the wall where the marking point 26 is provided. In this way, the mark position from ink reservoir 24 on the wall corresponds to the position at which the anchor should be applied to hang the wall hanging at the desired location. Membrane 12 is then peeled away from the wall hanging and can be reused.

In the preferred embodiment, the dimensions of device 10 are substantially small enough to fit behind a wall hanging into and extending from the wall hanging support structure. Therefore, in a preferred non-limiting exemplary embodiment, the overall height of marking member 20 is a ½ of an inch to 1/2 an inch. Dimensions of tab 16 are 1/2 inch in width by ¼ inch in length while the remaining portion of membrane 12 is ¾ inch in width by 1/2 inch in length. Each side of the diamond of ink reservoir portion 24 is about ¼ inch in length.

It should be noted, that the device 10 can also be used to mark the object being hung. By way of example, the problem arises when hanging paneling or such, that openings must be cut in the paneling, prior to it being mounted on the wall, to facilitate electrical outlets, telephone outlets, computer/tv outlets and the like. Again, accurate measuring must be done to determine where to cut the holes. If the holes are cut improperly and do not correspond to the actual outlets on the wall, the panel must be thrown out.

Device 10 can be utilized by applying device 10 at each corner of an outlet to be exposed so that marking member 20 corresponds to each corner of the outlet. Device 10 now is affixed to the wall and faces away therefrom. The paneling is then placed against the wall to come in contact with ink reservoir 24 of the respective corners of the outlet. As the paneling comes in contact with the respective devices 10, ink reservoirs 24 will mark the corners of the outlet on the reverse side of the paneling.

The paneling is then removed and, the markings define the opening required for the outlet. Devices 10 are then peeled from the wall and the process can be repeated at another outlet or the devices 10 may be used to hang wall hangings as discussed above.

1. A device for marking placement of an anchor for a wall having, said wall hanging having a support member, the device comprising:
a membrane adapted to be selectively and removably attached to a wall hanging;
a marking member extending from said membrane, said marking member having an ink reservoir formed therein, such that said marking member is dimensioned to be received by said support member when attached to said wall hanging to mark a wall at a position corresponding to a placement of said anchor to be received by said support member.

2. The device of claim 1, wherein the ink is washable ink.

3. The device of claim 1, wherein the marking member is shaped as a diamond.

4. The device of claim 1, wherein said membrane is clear.

5. The device of claim 1, further comprising an adhesive disposed on said membrane for attaching to said wall hanging.
